(19) United States
(12) Patent Application Publication
(10) Pub. No.: US 2020/0151701 A1
(43) Pub. Date: May 14, 2020

(54) A MOBILE SAFE SYSTEM FOR DEPOSITING CASH

(71) Applicant: OTOKOD OTOMASYON VE KODLAMA SISTEMLERI SANAYI VE TICARET ANONIM SIRKETI, Istanbul (TR)

(72) Inventor: Mehmet KAVI, Pendik, Istanbul (TR)

(73) Assignee: Otokod Otomasyon ve Kodlama Sistemleri A.S., Pendik, Istanbul (TR)

(21) Appl. No.: 16/611,655

(22) PCT Filed: Oct. 4, 2018
(86) PCT No.: PCT/TR2018/050549

§ 371 Date: Nov. 7, 2019

(30) Foreign Application Priority Data
Dec. 4, 2017 (TR) 2017/19429

(51) Int. Cl. G06Q 20/32; G06Q 20/10; E05G 1/00; G06Q 10/08

(52) U.S. Cl. CPC G06Q 20/3224; G06Q 10/0832; E05G 1/005; G06Q 20/1085

(57) ABSTRACT

The present invention is a mobile safe system (10) comprising a server (100) which manages the currency accounts of users, at least one client device (200) arranged to realize data exchange by means of said server (100). Accordingly, said client device (200) comprises a GPS module (250); said multiple servers (100) are arranged to guide one of pluralities of mobile safe vehicles (300) to the position of a client device (200) and to provide currency transfer to the currency account related to the client device (200) according to the money amount information put to the safe (310) in the mobile safe vehicle (300) from an operator device (340) related to the mobile safe vehicle (300) sent to the client device.

### TECHNICAL FIELD

The present invention relates to a mobile safe system comprising a server which manages the currency accounts of users and at least one client device arranged to provide data exchange by means of said server.

### PRIOR ART

Users can deposit cash to their accounts by means of depositing the cash directly to the bank, depositing the cash to the ATMs and to the night safes. Banks are open at delimited hours, and the ATMs and night safes providing depositing cash are located in delimited locations.

Companies may desire to deposit the cash, which they earn all day, to the bank at the end of the day. However, because of the abovementioned reasons, cash depositing process becomes difficult and in some cases, it becomes impossible. This leads to various problems like nightly interest losses and the risk of the money being stolen since the cash money stays in the company at night.

As a result, because of all of the abovementioned problems, an improvement is required in the related technical field.

### BRIEF DESCRIPTION OF THE INVENTION

The present invention relates to a mobile safe system and a method used by said mobile safe system, for eliminating the above mentioned disadvantages and for bringing new advantages to the related technical field.

An object of the present invention is to provide a mobile safe system and a method used by said mobile safe system facilitating depositing cash by the users.

In order to realize all of the abovementioned objects and the objects which are to be deducted from the detailed description below, the present invention is a mobile safe system comprising a server which manages the currency accounts of users, at least one client device arranged to realize data exchange by means of said server. Accordingly, said client device comprises a GPS module; said multiple servers are arranged to guide one of pluralities of mobile safe vehicles to the position of a client device and to provide currency transfer to the currency account related to the client device according to the money amount information put to the safe in the mobile safe vehicle from an operator device related to the mobile safe vehicle sent to the client device. Thus, the user can deposit cash at any position and the cash depositing process is facilitated.

In a preferred embodiment of the present invention, pluralities of mobile safe vehicles are provided.

In another preferred embodiment of the present invention, each mobile safe vehicle comprises at least one GPS module arranged to send position information to the server.

In another preferred embodiment of the present invention, the server is embodied to provide transfer of virtual money, which corresponds to the money deposited by means of the block chain method, to the currency account of the user.

In another preferred embodiment of the present invention, the mobile safe vehicle comprises money counter.

In another preferred embodiment of the present invention, the mobile safe vehicle comprises a printer arranged to produce receipt according to the amount of the cash deposited.

In another preferred embodiment of the present invention, the server is arranged to detect the present positions of the mobile safe vehicles and to determine the paths between the positions of mobile safe vehicles and the client device.

In another preferred embodiment of the present invention, the server is arranged to receive the present traffic condition from a traffic server and to calculate the durations of reaching of the mobile safe vehicles to the client device by means of following the determined paths.

In another preferred embodiment of the present invention, the server is arranged to guide the mobile safe vehicles, of which the determined reaching duration is the shortest, to the client device. Thus, the usage efficiency of the mobile safe vehicles is increased and the user realizes the money depositing process in an earlier manner.

In another preferred embodiment of the present invention, the server is embodied to calculate the reaching duration of the mobile safe vehicle to the client device and to send the information, related to said duration, to the client device.

The present invention is moreover a method for providing cash depositing in a currency account by the user. Accordingly, the improvement of the subject matter invention is characterized by comprising the steps of sending money depositing request to a server by means of the client device by the user, detecting the position of the client device by the server, guiding a mobile safe vehicle by the server to the position of the client device, in case cash is deposited to a safe carried by the mobile safe vehicle, producing a receipt related to amount of money deposited by a printer, sending the amount of money, deposited by an operator device, to the server, adding the amount, related to the deposited money amount, to the currency account of the user by the server.

In another preferred embodiment of the present invention, the following step is provided after the step of “sending the deposited money amount to the server by an operator device”:
transforming the deposited currency into the unit in the currency account of the user.

In another preferred embodiment of the present invention, after the step of “sending the deposited money amount to the server by an operator device”, the amount of virtual money, which corresponds to the deposited money, is calculated by means of the block chain method by the server.

The present invention is moreover a mobile safe vehicle comprising a safe for preserving money in order to be used in a mobile safe system, a money counter for counting money to be deposited to the safe, a printer for producing receipt, an operator device for providing data transfer with a server and a GPS module which sends position information to said server.

### BRIEF DESCRIPTION OF THE FIGURE

FIG. 1 is a representative view of the mobile safe system.

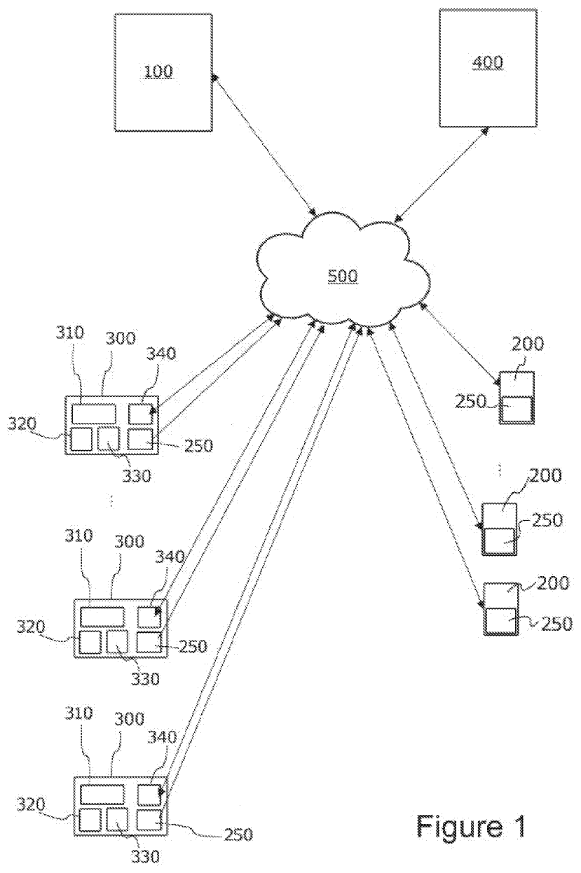

### DETAILED DESCRIPTION OF THE INVENTION

In this detailed description, the subject matter mobile safe system is explained with references to examples without forming any restrictive effect only in order to make the subject more understandable.

The present invention is a mobile safe system (10) for providing depositing cash money from the position desired by the user and a cash depositing method where said mobile safe system (10) is used.

Accordingly, the mobile safe system (10) comprises a server (100) which manages the currency accounts of the users. Said server (100) may add money to the remainder in the currency accounts of the recorded users. The server (100) can communicate with a bank server (400) for realizing this, and the remainders in the user currency accounts in the related bank of the bank server (400) can be arranged.

The mobile safe system (10) comprises mobile safe vehicles (300) which can communicate with the server (100). The mobile safe vehicles (300) are preferably armored vehicles which are suitable for carrying cash. The mobile safe vehicles (300) may comprise at least one safe (310) for preserving cash, a money counter (320) for producing receipt, a printer (330) and a GPS module (250). The mobile safe vehicles may transfer the position information to the server thanks to the GPS module (250).

The mobile safe system (10) comprises pluralities of operator devices (340) which can communicate with the server (100) and pluralities of client devices (200). The users who desire to deposit cash may send data to the server (100) by means of the client device (200) and may get appointment request from the server (100) for depositing cash. The server (100) may send data to the operator devices (340) and may provide the mobile safe vehicles (300) to be guided to the position of the user.

The client device (200) may comprise a GPS module (250) and may send the position information, obtained by means of GPS module (250), to the server (100). Thus, the server (100) may guide the mobile safe vehicles (300) to the position of the client device (200) according to the positions of the mobile safe vehicles (300) and the position of the client device (200).

The operator device (340) and the client device (200) may be mobile phones, paging devices, tablet computers, computers, etc. programmed in a suitable manner in order to realize the abovementioned processes.

The mobile safe system (10), whose details are given above, operates as follows:

The user notifies the money depositing request to the server (100) by means of the client device (200). The user can realize this process by means of an interface where the user enters through the client device (200) by using the user identity and password. The user may request money depositing for a later date by means of the client device (200). The client device (200) sends the present position information to the server (100) together with the money depositing request. In a possible embodiment, the client unit permits manual entry of the position and date where money is desired to be deposited by the user. The server (100) receives the request of the client and detects the positions of the present mobile safe vehicles (300). In a possible embodiment, the server (100) detects the paths between the mobile safe vehicles (300) and the client device (200) and provides assignment of the mobile safe vehicle (300), having the most suitable of these paths, to be sent to the client device (200) and provides guidance thereof to the position of the client unit.

After the mobile safe vehicle (300) arrives at the position of the client device (200), the user realizes the money counting process in the money counter (320) and afterwards, the user realizes the money depositing process to the safe (310). A receipt is produced related to the money deposited by the printer (330). The currency and the money amount deposited by the user by means of the operator device (340) are transferred to the server (100). The currency is transformed into a suitable unit by the server (100) when required and the required amounts are subtracted and the remaining amount is deposited to the currency account of the user. In an exemplary embodiment, the correspondence of the deposited cash to the virtual money is calculated and it is deposited to the virtual cash account of the user by means of the block chain method. The money depositing process can be realized by means of giving command to the bank server (400) by the server (100).

The server (100), the bank server (400), the client devices (200) and the operator devices (340) may communicate with each other by means of a communication network (500). Said communication network (500) is internet.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Mobile safe system
100 Server
200 Client device
250 GPS module
300 Mobile safe vehicle
310 Safe
320 Money counter
330 Printer
340 Operator device
400 Bank server
500 Communication network

1. A mobile safe system comprising a server which manages the currency accounts of users, at least one client device arranged to realize data exchange by means of said server, wherein said client device comprises a GPS module;
said multiple servers are arranged to guide one of pluralities of mobile safe vehicles to the position of a client device and to provide currency transfer to the currency account related to the client device according to the money amount information put to the safe in the mobile safe vehicle from an operator device related to the mobile safe vehicle sent to the client device.

2. A mobile safe system according to claim 1, wherein pluralities of mobile safe vehicles are provided.

3. A mobile safe system according to claim 1, wherein each mobile safe vehicle comprises at least one GPS module arranged to send position information to the server.

4. A mobile safe system according to claim 1, wherein the server is embodied to provide transfer of virtual money, which corresponds to the money deposited by means of the block chain method, to the currency account of the user.

5. A mobile safe system according to claim 1, wherein the mobile safe vehicle comprises money counter.

6. A mobile safe system according to claim 1, wherein the mobile safe vehicle comprises a printer arranged to produce receipt according to the amount of the cash deposited.

7. A mobile safe system according to claim 1, wherein the server is arranged to detect the present positions of the mobile safe vehicles and to determine the paths between the positions of mobile safe vehicles and the client device.

8. A mobile safe system according to claim 7, wherein the server is arranged to receive the present traffic condition from a traffic server and to calculate the durations of reaching of the mobile safe vehicles to the client device by means of following the determined paths.

9. A mobile safe system according to claim 8, wherein the server is arranged to guide the mobile safe vehicles, of which the determined reaching duration is the shortest, to the client device.

10. A mobile safe system according to claim 9, wherein the server is embodied to calculate the reaching duration of the mobile safe vehicle to the client device and to send the information, related to said duration, to the client device.

11. A method for providing cash depositing in a currency account by the user, wherein:
sending money depositing request to a server by means of the client device by the user,
detecting the position of the client device by the server,
guiding a mobile safe vehicle by the server to the position of the client device,
in case cash is deposited to a safe carried by the mobile safe vehicle, producing a receipt related to amount of money deposited by a printer,
sending the amount of money, deposited by an operator device, to the server,
adding the amount, related to the deposited money amount, to the currency account of the user by the server.

12. A mobile safe system according to claim 11, wherein the following step is provided after the step of “sending the deposited money amount to the server by an operator device”:
transforming the deposited currency into the unit in the currency account of the user.

13. A mobile safe system according to claim 11, wherein after the step of “sending the deposited money amount to the server by an operator device”, the amount of virtual money, which corresponds to the deposited money, is calculated by means of the block chain method by the server.

14. A mobile safe vehicle comprising a safe for preserving money in order to be used in a mobile safe system according to claim 1, a money counter for counting money to be deposited to the safe, a printer for producing receipt, an operator device for providing data transfer with a server and a GPS module which sends position information to said server.
